(19) United States
(12) Patent Application Publication
(10) Pub. No.: US 2011/0155252 A1
(43) Pub. Date: Jun. 30, 2011

(54) WATER-SAVING CONTROL DEVICE AND THE CONTROL METHOD THEREOF

(75) Inventors: Renzhong Li, Xiamen (CN); Hao Deng, Xiamen (CN)

(73) Assignee: XIAMEN SOLEX HIGH-TECH INDUSTRIES CO., LTD., Xiamen (CN)

(21) Appl. No.: 12/809,073

(22) PCT Filed: Apr. 7, 2009
(86) PCT No.: PCT/CN2009/071182

§ 371 Date: Jun. 18, 2010

(30) Foreign Application Priority Data
Apr. 9, 2008 (CN) 200810070897.X

(51) Int. Cl. F15D 1/00

(52) U.S. Cl. 137/1; 137/41

(57) ABSTRACT

A water-saving control device and the control method thereof is used in an inflowing waterway. The control device has an internal floating body disposed in an upper cover, a spring and a main body. The upper end of the internal floating body forms a head, which can be hermetically cooperated with an opening of the upper end of the upper cover. The side wall of the internal floating body has a water inlet. The side wall of the lower part of the main body has a flow adjusting opening and the lower part of the internal floating body is movable in the main body for adjusting the flow opening. The lower end of the spring abuts against the inside of the main body while the upper end abuts against the internal floating body to seal the opening of the upper cover.

### FIELD OF THE INVENTION

The present invention relates to a device for controlling the water flow and a control method for water-saving applied in the sanitary ware products, especially relates to a water-saving control device and the control method thereof which can be applied in a shower structure for restricting the water yield.

### BACKGROUND OF THE INVENTION

Water shortage is a global problem, so the issue of saving water needs to be advocated in our daily lives nowadays. Regarding the water yield of the shower, some developed western countries has regulations that the water yield of shower should not exceed 9.6L/per minute. However, the existing traditional shower only focuses on the improvement of the shower's exterior appearance or the massage effects of water outflow while neglects controlling its water yield, the water yield is usually adjusted by a valve which is connected outside of the shower, so the water yield has to be sensed by human and could not be effectively controlled.

### SUMMARY OF THE INVENTION

The object of the present invention is to provide a water-saving control device and the control method thereof, which can automatically adjust the water yield and effectively achieve the function of water-saving.

The object of the present invention is designed by such principle: a control device is disposed in the inflowing waterway, the water yield is controlled by the change of the pressure of the inflowing water stream, thus the water yield is automatically adjusted.

The technical solution is: a water-saving control device, which is disposed in the inflowing waterway, comprising an upper cover, an internal floating body, a spring and a main body; the internal floating body is disposed in the upper cover and its upper end forms a head which can be hermetically cooperated with an enclosing opening of the upper end of the upper cover, the side wall of said internal floating body has a water inlet; the spring is disposed in the internal floating body; the internal floating body and the spring are restricted in the upper cover by the cooperation of the upper part of the main body and the upper cover, the side wall of the lower part of the main body has a flow adjusting opening, the lower part of the internal floating body is movably disposed in the main body for movably adjusting the size of the flow adjusting opening; the lower end of the spring is abutted against the inside of the main body while its upper end is abutted against the internal floating body for sealing the enclosing opening of the upper cover.

Said upper cover is a sleeve with an inner chamber, its outer periphery has a circular groove, a sealing ring is disposed in said circular groove for the hermetically cooperation between the upper cover and the inner wall of the waterway pipe.

The inner periphery of the upper end of the upper cover forms the enclosing opening, a gradually broader inclined conducting surface is abutted to the lower part of the enclosing opening.

The lower part of the inner periphery of the upper cover has a circular retaining groove.

Said internal floating body is a cylinder with a hollow chamber and the upper part of which forms a head, the external diameter of the head is greater than the internal diameter of said enclosing opening, the lateral margin of said head is an inclined surface, an embedding groove for receiving the sealing ring embedded therein is abutted to lower part of the inclined surface.

The hollow chamber of the internal floating body forms a horn mouth gets broader gradually top-down.

Said main body is a seat with a chamber, its upper part forms a reduced neck to be embedded and received in the upper cover, the side wall of the main body located on the lower part of the reduced neck has a flow adjusting opening which communicates with said chamber.

A circular flange is disposed on the reduced neck to be embedded and received in the circular retaining groove of said upper cover.

A control method for water-saving, which applies a water-saving control device disposed in the inflowing waterway; said control device comprises an upper cover, an internal floating body, a spring and a main body; said internal floating body is disposed in said upper cover and the upper end of which forms a head which can be hermetically cooperated with an enclosing opening of the upper end of the upper cover, the side wall of said internal floating body has a water inlet; the spring is disposed in the internal floating body; the internal floating body and the spring are restricted in the upper cover by the cooperation of the upper part of the main body and the upper cover, the side wall of the lower part of the main body has a flow adjusting opening, the lower part of the internal floating body is movably disposed in the main body; the lower end of the spring is abutted against in the main body while its upper end is abutted against the internal floating body for sealing the enclosing opening of the upper cover;

the size of the flow adjusting opening of the main body is adjusted by the up and down resilient movement of the internal floating body in the upper cover and the main body, so the water yield will be ensured to be controlled within a predetermined water yield range.

In the applied technical solution, since the present invention disposes a water-saving control device in the inflowing waterway pipe, the internal floating body of said water-saving control device can resiliently move up and down in the upper cover and the main body for adjusting the size of the flow adjusting opening of the main body; when the water pressure is excessively great, the internal floating body will overcome the resilience of the spring and move downward for diminishing the size of the inflow adjusting opening, thus the water yield is restricted, when the water pressure increases continuously, the internal floating body will move downward to increase the inflowing water of the upper cover, but when the flow adjusting opening is diminished, the water stream of the inner chamber will exert an upward pushing force to the internal floating body, then the internal floating body will continuously move upward while the inflowing water of the main body decreases, so due to the water stream and the spring, the internal floating body will float up and down for automatically adjusting; since the upper end of the internal floating body of the present invention applies a head structure, so the applied force area of the spring will be effectively increased, the water yield will be ensured to be controlled within a predetermined water yield range, the function of saving water will be realized.

### BRIEF DESCRIPTION OF THE DRAWINGS

FIG. 1 is the perspective exploded view of the present invention;

FIG. 2 is the schematic view of the present invention when it is applied in a waterway;

FIG. 3 is the sectional view of the first operation status of the present invention (prevent backflow status);

FIG. 4 is the sectional view of the second operation status of the present invention (open status);

FIG. 5 is the sectional view of the third operation status of the present invention (inflow-restriction status);

FIG. 6 is the comparison view of the water yield of after the water-saving plate is added.

Diagram Legend: upper cover 1, inner chamber 11, circular groove 12, enclosing opening 13, inclined conducting surface 14, circular retaining groove 15; internal floating body 2, hollow chamber 21, head 22, inclined surface 221, embedding groove 23, water inlet 24, horn mouth 25; main body 4, chamber 41, reduced neck 42, circular flange 421, flow adjusting opening 43; spring 3, sealing ring 5, sealing ring 6

### DETAILED DESCRIPTION OF THE EMBODIMENTS

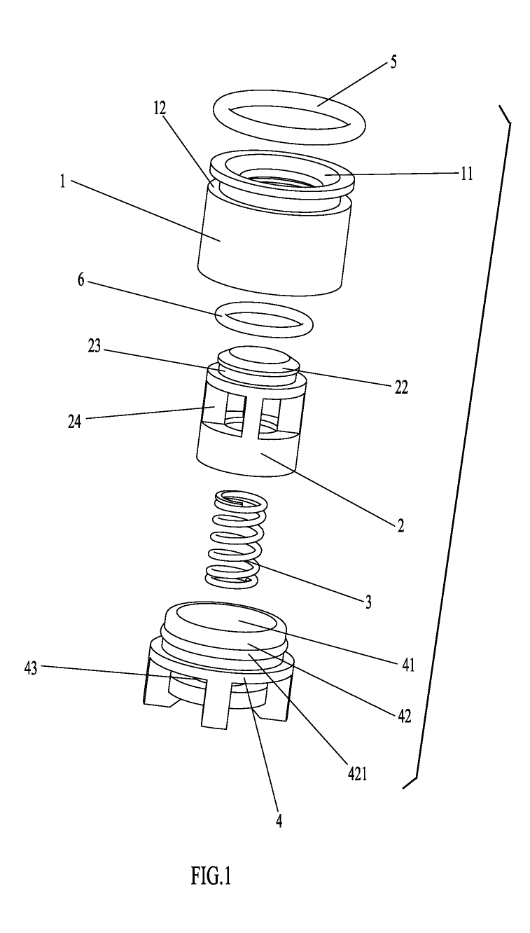

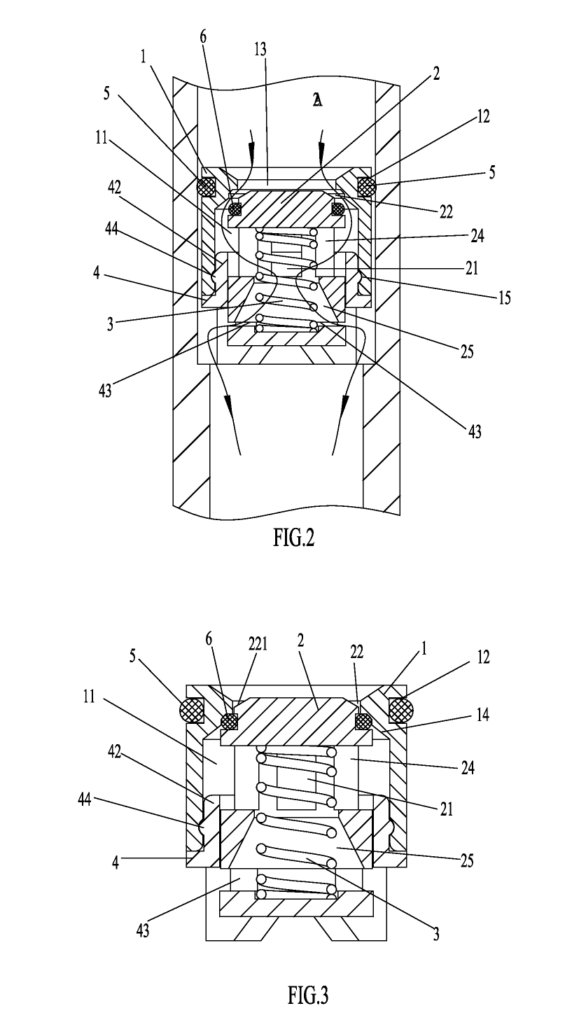

As illustrated in FIG. 1, FIG. 2, the water-saving control device of the present invention is disposed in the inflowing waterway pipe A; said control device comprises an upper cover 1, an internal floating body 2, a spring 3 and a main body 4;

The upper cover 1 is a sleeve with an inner chamber 11, its outer periphery has a circular groove 12, a sealing ring 5 is disposed in said circular groove 12 for the hermetically cooperation between the upper cover 1 and the inner wall of the waterway pipe A; the inner periphery of the upper end of said upper cover 1 forms an enclosing opening 13, a gradually broader inclined conducting surface 14 is abutted to the lower part of the enclosing opening 13, the lower part of the inner periphery of the upper cover 1 has a circular retaining groove 15;

The internal floating body 2 is a cylinder with a hollow chamber 21 and the upper part of which forms a head 22, the external diameter of the head 22 is greater than the internal diameter of said enclosing opening 13, the lateral margin of said head 22 is an inclined surface 221, an embedding groove 23 for receiving the sealing ring 6 embedded therein is abutted to lower part of the inclined surface 221, at least two water inlets 24 communicate with the hollow chamber 21 are disposed on the side wall of the cylinder of the lower part of the head 22, a horn mouth 25 gets broader gradually top-down is formed in the hollow chamber 21 of the internal floating body 2 of the lower part of the water inlets 24;

The main body 4 is a seat with a chamber 41, the inner chamber of said chamber 41 is adapted to the outer diameter of the internal floating body 2, the upper part of said chamber 41 forms a reduced neck 42 to be extended and received in the upper cover 1, a circular flange 421 is disposed on said reduced neck 42 to be embedded and received in the circular retaining groove 13 of said upper cover 1, the side wall of the main body located on the lower part of the reduced neck 42 has a flow adjusting opening 43 communicates with said chamber 41.

Combined with FIG. 3, the spring 3 is disposed in the hollow chamber 21 of the internal floating body 2, the spring 3 and the hollow 21 are both disposed in the chamber 41 of the main body 4, the main body 4 then brings the spring 3 and the internal floating body 2 to be extended and received in the inner chamber 11 of the upper cover 1 from the lower part of the upper cover 1, the circular flange 421 of the main body 4 is embedded and received in the circular retaining groove 13 of the upper cover 1, so when the main body 4 cooperates with the upper cover 1, the internal floating body 2 will be restricted in the space formed by the upper cover 1 and the main body 4; the lower part of the spring 3 is abutted against the bottom of the chamber 41 of the main body 4 while its upper part is abutted against the head 22 of the internal floating body 2 and cooperates with the enclosing opening 13 of the upper cover 1, because of the inclined conducting surfaces 12, 221 and the sealing ring 6, said head 22 will seal the enclosing opening 13, then the waterway pipe A will be in the prevent backflow status.

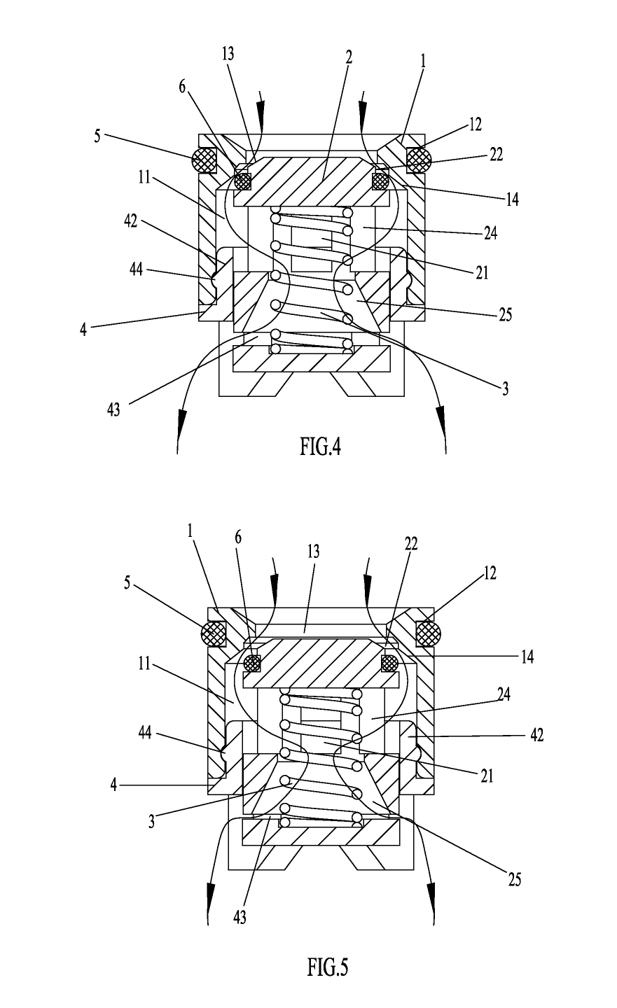

As illustrated in FIG. 4, FIG. 5, when the waterway is open and the shower is under use, the water stream of the waterway pipe A flows into the shower by the water-saving control device of the present invention, the pressure of water stream will act on the head 22 of the internal floating body 2, when the pressure of the water stream exceeds the resilience of the spring 3, the internal floating body 2 will move downward to the inside of the main body 4 relative to the upper cover 1, the spring 3 is compressed and store energy; meanwhile, the head 22 will open the enclosing opening 13 of the upper 1, the water stream will flow into the inner chamber 11 of the upper cover 1 along the interval between the enclosing opening 13 and the head 22, and then flows into the hollow chamber 21 of the internal floating body 2 along the water inlet 24 of the side wall of the internal floating body 2 and flows out of the flow adjusting opening 43 of the main body 4 along the horn mouth 24, at this moment the water-saving control device is in open status.

As illustrated in FIG. 5, when the pressure of water stream keeps on increasing, the internal floating body 2 will keep on moving downward, the interval between the enclosing opening 3 and the head 22 will get broader, so the water flows into the inner chamber 11 of the upper cover will be increased, but after the internal floating body 2 moves downward, the size of the flow adjusting opening 43 of the main body will be diminished, so the water yield will be decreased, thus the water yield will be restricted, it will realize the object of water yield restriction; when the water pressure increases, the inflowing water will be increased along with the downward movement of the internal floating body 2, the water stream of the inner chamber 11 of the upper cover 1 will exert an upward pushing force to the internal floating body 2 when the size of flow adjusting opening 43 is diminished, then the internal floating body 2 will keep on moving upward to decrease the interval between the enclosing opening 13 and the head 22, so the internal floating body will float up and down for automatically adjusting due to the water stream and the spring 3, so the water yield will be controlled within a predetermined water yield range, and the function of water-saving will be realized.

In the present embodiment, the water-saving control device is designed according to the parameter of the diameter of the inflowing waterway pipe, so the diameter of the head 22 of the upper part of the internal floating body 2 is 7.8 mm, the main technical parameters of the applied spring 3 are: the effective number of circles N=6, the hardness of the surface is 45˜55 HRC, the service life is 300,000 times, the diameter is 5 mm.

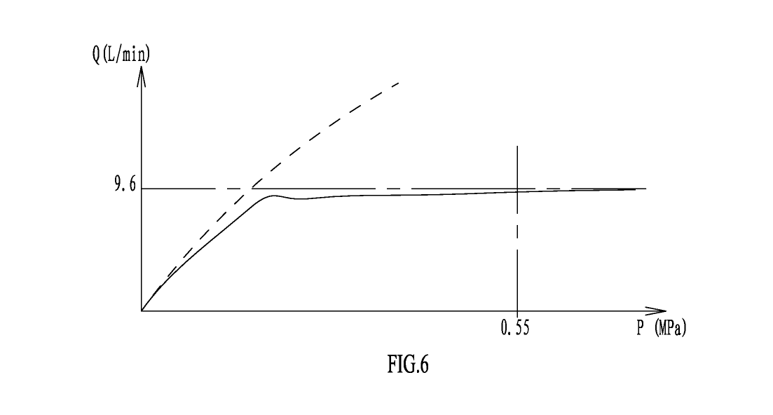

As illustrated in FIG. 6, it is the comparison view of the water yield after the water-saving control device is added in the inflowing waterway pipe A, the dotted line shows the water yield when the water-saving control device hasn't been added, the full line shows the water yield after the water-saving control device has been added, it can be inferred from the comparison view that the water yield will be operatively controlled within 9.6 L/per minute after adding the water-saving control device of the present invention.

Since the upper end of the internal floating body 2 of the present invention applies a head 22, the spring 3 is abutted against the head 22, in operation, the pressure of inflowing water stream can directly exert on the spring 3 by the head 22, the applied force on the spring 3 will be even, and its transformation is consistent, thus the water yield can be effectively adjusted and is ensured to be controlled within 9.6 L/per minute.

### INDUSTRIAL APPLICABILITY

The water-saving control device of the present invention is disposed in the inflowing waterway, its internal floating body can resiliently move up and down in the upper cover and the main body for adjusting the size of the flow adjusting opening, so the water yield will be ensured to be controlled within a predetermined water yield range, the function of water-saving will be realized and the it has a good industrial applicability.

1. A water-saving control device, which is disposed in the inflowing waterway, characterizes in that said control device comprises an upper cover, an internal floating body, a spring and a main body; the internal floating body is disposed in the upper cover and its upper end forms a head which can be hermetically cooperated with an enclosing opening of the upper end of the upper cover, the side wall of said internal floating body has a water inlet; the spring is disposed in the internal floating body; the internal floating body and the spring are restricted in the upper cover by the cooperation of the upper part of the main body and the upper cover, the side wall of the lower part of the main body has a flow adjusting opening, the lower part of the internal floating body is movably disposed in the main body for movably adjusting the size of the flow adjusting opening; the lower end of the spring is abutted against the inside of the main body while its upper end is abutted against the internal floating body for sealing the enclosing opening of the upper cover.

2. The water-saving control device according to claim 1, characterizes in that said upper cover is a sleeve with an inner chamber, its outer periphery has a circular groove, a sealing ring is disposed in said circular groove for the hermetically cooperation between the upper cover and the inner wall of the waterway pipe.

3. The water-saving control device according to claim 1, characterizes in that the inner periphery of the upper end of the upper cover forms the enclosing opening, a gradually broader inclined conducting surface is abutted to the lower part of the enclosing opening.

4. The water-saving control device according to claim 1, characterizes in that the lower part of the inner periphery of the upper cover has a circular retaining groove.

5. The water-saving control device according to claim 1, characterizes in that said internal floating body is a cylinder with a hollow chamber and the upper part of which forms a head, the external diameter of the head is greater than the internal diameter of said enclosing opening, the lateral margin of said head is an inclined surface, an embedding groove for receiving the sealing ring embedded therein is abutted to lower part of the inclined surface.

6. The water-saving control device according to claim 5, characterizes in that the hollow chamber of the internal floating body forms a horn mouth gets broader gradually top-down.

7. The water-saving control device according to claim 1, characterizes in that said main body is a seat with a chamber, its upper part forms a reduced neck to be embedded and received in the upper cover, the side wall of the main body located on the lower part of the reduced neck has a flow adjusting opening communicates with said chamber.

8. The water-saving control device according to claim 7, characterizes in that a circular flange is disposed on the reduced neck to be embedded and received in the circular retaining groove of said upper cover.

9. A control method for water-saving, characterizes in that a water-saving control device is disposed in the inflowing waterway; said control device comprises an upper cover, an internal floating body, a spring and a main body; said internal floating body is disposed in said upper cover and the upper end of which forms a head which can be hermetically cooperated with an enclosing opening of the upper end of the upper cover, the side wall of said internal floating body has a water inlet; the spring is disposed in the internal floating body; the internal floating body and the spring are restricted in the upper cover by the cooperation of the upper part of the main body and the upper cover, the side wall of the lower part of the main body has a flow adjusting opening, the lower part of the internal floating body is movably disposed in the main body; the lower end of the spring is abutted against in the main body while its upper end is abutted against the internal floating body for sealing the enclosing opening of the upper cover;
the size of the flow adjusting opening of the main body is adjusted by the up and down resilient movement of the internal floating body in the upper cover and the main body, so the water yield will be ensured to be controlled within a predetermined water yield range.

10. The control method for water-saving according to claim 9, characterizes in that said upper cover is a sleeve with an inner chamber, its outer periphery has a circular groove, a sealing ring is disposed in said circular groove for the hermetically cooperation between the upper cover and the inner wall of the waterway pipe; the inner periphery of the upper end of the upper cover forms an enclosing opening, a gradually broader inclined conducting surface is abutted to the lower part of the enclosing opening, the lower part of the inner periphery of the upper cover has a circular retaining groove.

11. The control method for water-saving according to claim 9, characterizes in that said internal floating body is a cylinder with a hollow chamber and the upper part of which forms a head, the external diameter of the head is greater than the internal diameter of said enclosing opening, the lateral margin of said head is an inclined surface, an embedding groove for receiving the sealing ring embedded therein is abutted to lower part of the inclined surface; the hollow chamber of the internal floating body forms a horn mouth gets broader gradually top-down.

12. The control method for water-saving according to claim 9, characterizes in that said main body is a seat with a chamber, its upper part forms a reduced neck to be embedded and received in the upper cover, the side wall of the main body located on the lower part of the reduced neck has a flow adjusting opening which communicates with said chamber, a circular flange is disposed on the enclosing neck to be embedded and received in the circular retaining groove of said upper cover.

13. The water-saving control device according to claim 2, characterizes in that the lower part of the inner periphery of the upper cover has a circular retaining groove.

14. The water-saving control device according to claim 3, characterizes in that the lower part of the inner periphery of the upper cover has a circular retaining groove.
